(19) United States
(12) Patent Application Publication
(10) Pub. No.: US 2003/0025729 A1
(43) Pub. Date: Feb. 6, 2003

(54) Method and apparatus for viewing and marking up a design document

(75) Inventor: Kenneth L. Davis, San Diego, CA (US)

Correspondence Address: GATES & COOPER LLP, HOWARD HUGHES CENTER, 6701 CENTER DRIVE WEST, SUITE 1050, LOS ANGELES, CA, 90045, US

(73) Assignee: Autodesk, Inc.

(21) Appl. No.: 09/916,391

(22) Filed: Jul. 26, 2001

(51) Int. Cl. G09G 5/00

(52) U.S. Cl. 345/753

(57) ABSTRACT

One or more embodiments of the invention provide a method, apparatus, and article of manufacture for displaying a markup of a graphical image. A first client receives an identification of a second client to participate in a chat session. A graphical image is displayed on the first client where a command is selected to markup the graphical image. In response to the command, markup information is stored in a markup file. Such markup information comprises a markup entity, a source reference that identifies the graphical image, and an orientation that indicates how the graphical image should be displayed with regard to the markup entity. The markup file is transmitted across the network to the second client through the chat session, wherein the markup entity is caused to be displayed in the orientation on the graphical image.

### CROSS-REFERENCE TO RELATED APPLICATIONS

This application is related to the following co-pending and commonly-assigned patent applications, all of which applications are incorporated by reference herein:

U.S. patent application Ser. No. 09/501,474, entitled “INTELLIGENT DRAWING REDLINING AND COMMENTING FEATURE”, by Vincent Joseph Abeyta et. al., Attorney Docket No. 30566.77-US-U1, filed on Feb. 9, 2000;

U.S. patent application Ser. No. 09/488,308, entitled “SHAPE OBJECTS HAVING AUTHORABLE BEHAVIORS AND APPEARANCES”, by Lawrence Felser, et. al., Attorney Docket No. 30566.39-US-C1, filed on Jan. 20, 2000;

U.S. patent application Ser. No. 09/088,116, entitled “POSITIONING AND ALIGNMENT AIDS FOR SHAPE OBJECTS WITH AUTHORABLE BEHAVIORS AND APPEARANCES”, by Lawrence Felset, et. al., Attorney Docket No. 30566.38-US-O1, filed on Jun. 1, 1998;

U.S. patent application Ser. No. 09/450,207, entitled “FRAMEWORK FOR OBJECTS HAVING AUTHORABLE BEHAVIORS AND APPEARANCES”, by Lawrence Felser, et. al., Attorney Docket No. 30566.40-US-C1, filed on Nov. 29, 1999; and

U.S. patent application Ser. No. 09/527,104, entitled “REDLINE EXTENSIBLE MARKUP LANGUAGE (XML) SCHEMA”, by Steven J. Demopoulos, et. al., Attorney Docket No. 30566.103-US-01, filed on Mar. 16, 2000.

### BACKGROUND OF THE INVENTION

1. Field of the Invention

The present invention relates generally to viewing and marking up documents, and in particular, to a method, apparatus, and article of manufacture for viewing and marking up design documents in an instant message that may utilize extensible markup language (XML).

2. Description of the Related Art

The Internet is widely utilized to transmit and receive information in the form of web pages that are translated/interpreted and displayed by a web browser on a computer. So that a browser can interpret and display a web page, document definition languages and standard programming languages are utilized to define the web page. For example, hypertext markup language (HTML) is widely used to define web pages. However, HTML utilizes a predefined set of “tags” to describe elements on the web page. As a result, extensible markup language (XML) has become and is becoming more widely used on the internet XML is more flexible than HTML and allows tags to be defined by the developer of the web page. Thus, tags for virtually any data items such as a product, sales representative, and or amounts due, can be used for specific applications, allowing web pages to function like database records.

In addition to displaying information in a web browser, instant messaging has become a popular application in use today on the Internet. In instant messaging, a program informs users when any individuals in their list of “buddies” (colleagues, workgroup members, friends, etc.) log onto the network so they can chat. Instant messaging software also notifies a user if a “buddy” sends them a message. A “chat” is the capability to conference with one or more users on a local area network (LAN), on the Internet or via a BBS (bulletin board system). The chat is accomplished by typing on the keyboard, not speaking, and each keystroke may be transmitted as it is pressed. Instant messaging service requires that an instant messaging application be resident on a user's computer and the user must have Internet access through an Internet service provider.

Both instant messaging and web browsing allow users to communicate and collaborate with each other from physically different locations. However, in the computer aided design (CAD) and graphics environment, users may often desire to propose changes to drawings, documents, or graphics to other users. Such drawing changes may be in the form of markups such as arrows, balloons, clouds, ellipses, poly-lines, rectangles, circles, text, etc. on top of an existing graphic image.

The prior art mechanism for collaborating with another user regarding drawing changes is to email or transfer (e.g., by facsimile) an entire design document/drawing file including the markups to another user. For example, a user may markup a drawing on one computer, email or transfer the marked up drawing to another user, and then initiate a chat session with the other user to discuss the changes. However, graphic files involved in CAD applications and models are often very large. Accordingly, such a transmission mechanism is slow, time consuming, and inefficient. Further, such a mechanism involves multiple steps on behalf of the user. For example, a user must view the drawing and changes in one application and discuss the changes in a separate instant messaging application. Additionally, there is no mechanism for providing markups to a design document during an instant messaging application.

What is needed is a mechanism for utilizing an instant messaging application with functionality for marking up a design document displayed by both users in a chat session. Additionally, what is needed is an integrated instant messaging application that allows a user to instant message markup information and text to another user.

### SUMMARY OF THE INVENTION

An instant messaging application provides the ability to markup a graphical image and transmit the markup information in an efficient and expeditious manner. A first and second client are identified to participate in a chat session across a network. A graphical image is displayed on one client and marked up by the client. Such markups may comprise graphical images (e.g., circles, ellipses, squares, arrows, clouds, etc.) and/or may comprise text. Additionally, instant messaging text may also be provided. Once marked up, the markup information (that includes the markup entities used to markup the graphical image, a source reference identifying the graphical image, and an orientation that indicates how the markups should be displayed with respect to the graphical image) is stored in a markup file separately from the graphical image.

The markup file is then transmitted through the chat session to the second client. The second client processes the markup file to determine the graphical image being edited. Thereafter, the second client may load the graphical image from local storage and display the markup entities in the indicated orientation as indicated in the markup information.

### BRIEF DESCRIPTION OF THE DRAWINGS

Referring now to the drawings in which like reference numbers represent corresponding parts throughout:

FIG. 1 schematically illustrates a hardware and software environment in accordance with one or more embodiments of the invention;

FIG. 2A illustrates an instant messaging application window in accordance with one or more embodiments of the invention;

FIG. 2B illustrates the instant messaging application window of FIG. 2A upon the selection of a particular member in accordance with one or more embodiments of the invention;

FIG. 2C illustrates the instant messaging application window of FIG. 2B upon the selection of a command to send an instant message;

FIG. 2D illustrates the instant messaging application window of FIG. 2C after instant message text has been entered and several markup entities have been inserted and displayed in accordance with one or more embodiments of the invention; and

FIG. 3 is a flowchart illustrating the instant messaging process in accordance with one or more embodiments of the invention.

### DETAILED DESCRIPTION OF THE INVENTION

In the following description, reference is made to the accompanying drawings which form a part hereof, and which is shown, by way of illustration, several embodiments of the present invention. It is understood that other embodiments may be utilized and structural changes may be made without departing from the scope of the present invention.

Overview

An instant messaging application is configured to initialize a chat session, transmit a markup file, and display markup information from the markup file on a display device. Additionally, the instant messaging application may be configured to create/generate the markup information and file in response to user commands/selections.

Hardware and Software Environment

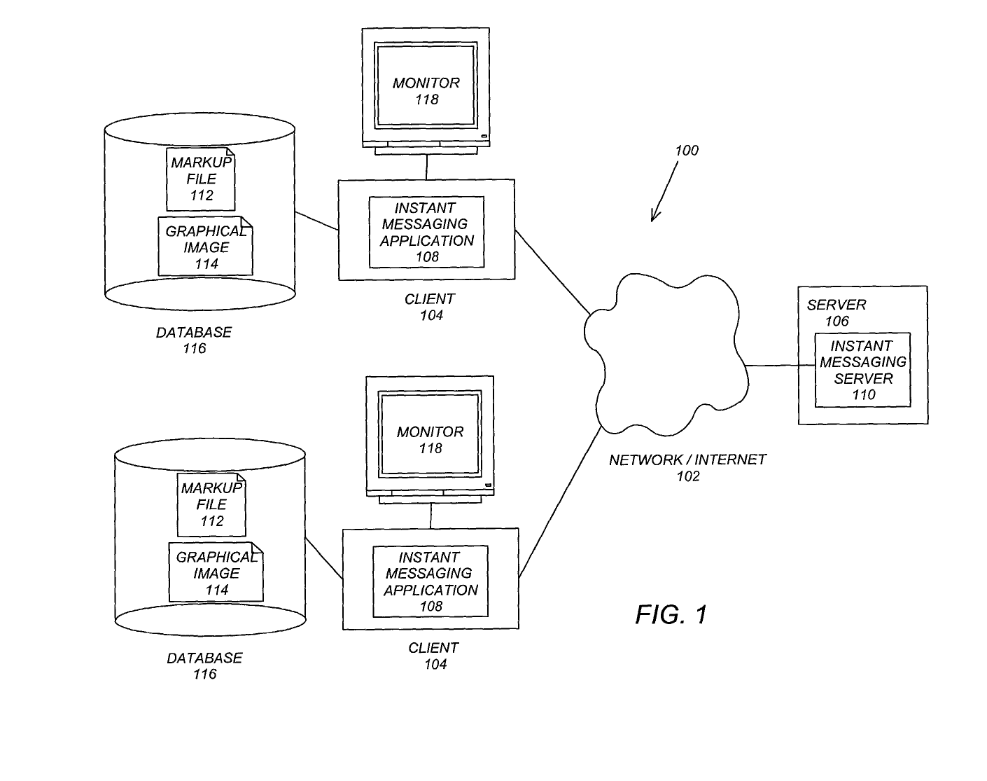

FIG. 1 schematically illustrates a hardware and software environment in accordance with one or more embodiments of the invention, and more particularly, illustrates a typical distributed computer system 100 using a network 102 to connect client computers 104 to server computers 106. A typical combination of resources may include a network 102 comprising the Internet, LANs, WANs, SNA networks, or the like, clients 104 that are personal computers or workstations, and servers 106 that are personal computers, workstations, minicomputers, or mainframes.

In accordance with one or more embodiments of the invention, the Internet 102 connects client computers 104 executing instant messaging applications 108 to server computers 106 executing instant messaging servers 110. Instant messaging applications 108 enable client 104 to initialize a chat session with another client 104. During and through a chat session, the instant messaging application 108 provides for transmitting text and a markup file 112 between clients 104. Such a chat session may be established through and utilize server 106 as a conduit for transferring the markup file 112 and text. Additionally, instant messaging application 108 may interact with a local database 116 to obtain access to a markup file 112 and/or a graphical image 114. Once a markup file 112 has been obtained, the instant messaging application 108 provides for displaying the markup information on a display device such as monitor 118.

The instant messaging application 108 of the present invention may be a implemented as a stand-alone application or as one or more additional features to currently existing instant messaging applications 108 such as those available from America Online (AOL), Microsoft, or Yahoo. The instant messaging server 110 may act as a conduit for instant messaging application 108. For example, users of a particular instant messaging application 108 may be required to register with instant messaging server 110 to enable use of the instant messaging application 108. In such an embodiment, chat sessions are initialized through, and communications may be transmitted through instant messaging server 110.

Generally, the components of the invention 104-118 all comprise logic and/or data that is embodied in or retrievable from device, medium, signal, or carrier, e.g., a data storage device, a data communications device, a remote computer or device coupled to the computer across a network or via another data communications device, etc. Moreover, this logic and/or data, when read, executed, and/or interpreted, results in the steps necessary to implement and/or use the present invention being performed.

Thus, embodiments of the invention may be implemented as a method, apparatus, or article of manufacture using standard programming and/or engineering techniques to produce software, firmware, hardware, or any combination thereof. The term “article of manufacture” (or alternatively, “computer program product”) as used herein is intended to encompass logic and/or data accessible from any computer-readable device, carrier, or media.

Those skilled in the art will recognize many modifications may be made to this exemplary environment without departing from the scope of the present invention. For example, those skilled in the art will recognize that any combination of the above components, or any number of different components, including different logic, data, different peripherals, and different devices, may be used to implement the present invention, so long as similar functions are performed thereby.

Embodiment Details

In the system 100, an instant messaging application 108 is configured to initialize a chat session, transmit a markup file 112, and display markup information from the markup file 112 on a display device or monitor 118. Additionally, the instant messaging application 108 may be configured to create/generate the markup information and file 112 in response to user commands/selections. Details regarding this system 100 follow.

One or more embodiments of the invention may overcome the deficiencies of the prior art described above. For example, one problem with remote users of CAD systems is that the graphics data/images 114 involved in CAD applications and models are very large. While many technologies have been and are being developed to reduce the size of such graphic images 114, embodiments may take advantage of the fact that most users of a graphical image 114 already have the graphical image 114 stored locally. Accordingly, instant messaging application 108 may interact with a local database 116 to obtain access to locally-stored graphical images 114.

Markup information may be obtained in a variety of manners. For example, a markup application may enable a user to markup or provide comments for a graphical image 114. Alternatively, as described above, the markup information may be generated by an instant messaging application 108 and may subsequently be stored in a markup file 112. Details regarding such generation are described below. Once in the form of a markup file 112, the markup information may be displayed, copied, transmitted, etc. to other clients 104. For example, the markup file 112 may be transmitted to an instant messaging application 108 of another client 104 where the markup information identified in the markup file 112 is displayed on a monitor 118 attached to client 104.

By separating the markup file 112 from the graphical image 114, a small file may be used to define the markup information thereby enabling expedited transmission and display on clients 104. In order to maintain the markup file 112 separate from the graphical image 114 being marked up, the markup file 112 must contain a source reference that identifies the graphical image 114 and may also contain an orientation tag that indicates how the source graphic image 114 should be displayed with regard to the markup. The markup information also identifies a markup entity that specifies the type of markup to be displayed. For example, the markup entity may comprise text, an arrow, a balloon, a cloud, an ellipse, a poly-line, a rectangle, a circle, etc.

XML may be used to define the markup information within markup file 112. Using XML, the markup file 112 being transmitted to a client 104 may be reduced to XML that specifies a markup entity, a source reference tag identifying the source graphical image 114, and an orientation tag that indicates how the source graphical image 114 should be displayed with regard to the markup.

Table 1 is an example of an XML-based markup file 112 that demonstrates the small amount of data needed to facilitate markup collaboration. Table 1 indicates the use of an arrow (i.e., the arrow tag) and text (i.e., the text tag) indicating an issue with the design as well as the coordinates of the view (i.e., the Point2d and camera tag references) associated with the markup. The software using the XML of Table 1 will open a local version of the view “tank.hgs” (in the orientation and view specified by Point2d and CameraXXX tags) and overlay the arrow (defined by the various Point2d tags) and text (i.e., “this tank is going to blow up”) in the specified orientation.

As illustrated in Table 1, various tags may be used to define a markup entity and display characteristics of the markup entity and graphical image 114. The flexibility of XML allows various different markup entities to be defined and used. An XML schema may also be used to validate XML. Such an XML schema is further described in U.S. patent application Ser. No. 09/527,104, entitled “REDLINE EXTENSIBLE MARK UP LANGUAGE (XML) SCHEMA”, by Steven J. Demopoulos, et. al., Attorney Docket No. 30566.103-US-01, filed on Mar. 16, 2000, which application is fully incorporated by reference herein.

As described, a markup file 112 defined in XML is used by an instant messaging application 108 to quickly chat and display markup information on a graphical image 114 at different clients 104. In addition, using the instant messaging application 108, a client 104 may specify or define a particular user or group of users to participate in a chat session. Such user participation may be limited or defined based on workgroups, membership in a group, appropriate username and passwords, access privileges, etc.

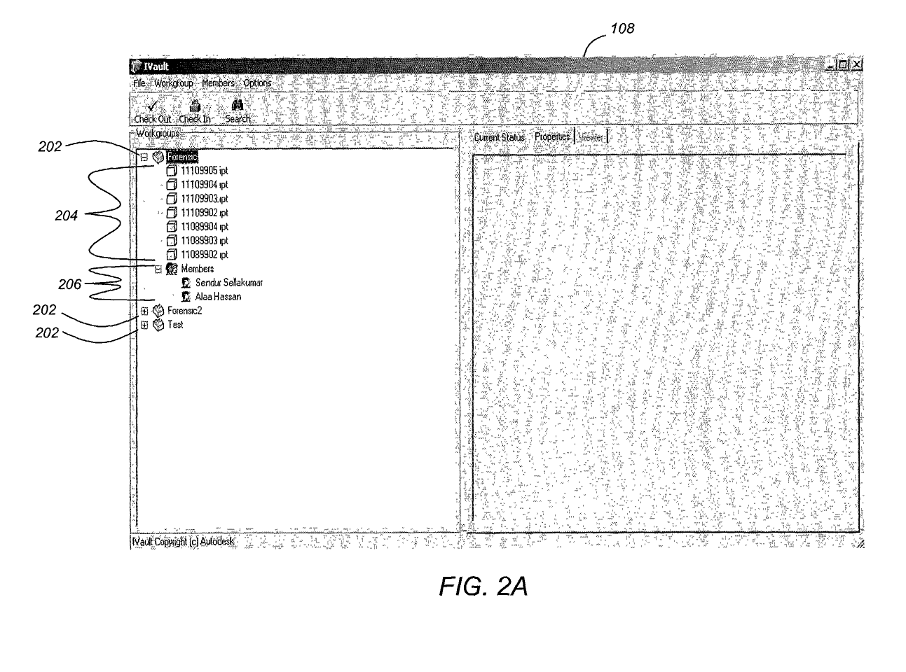

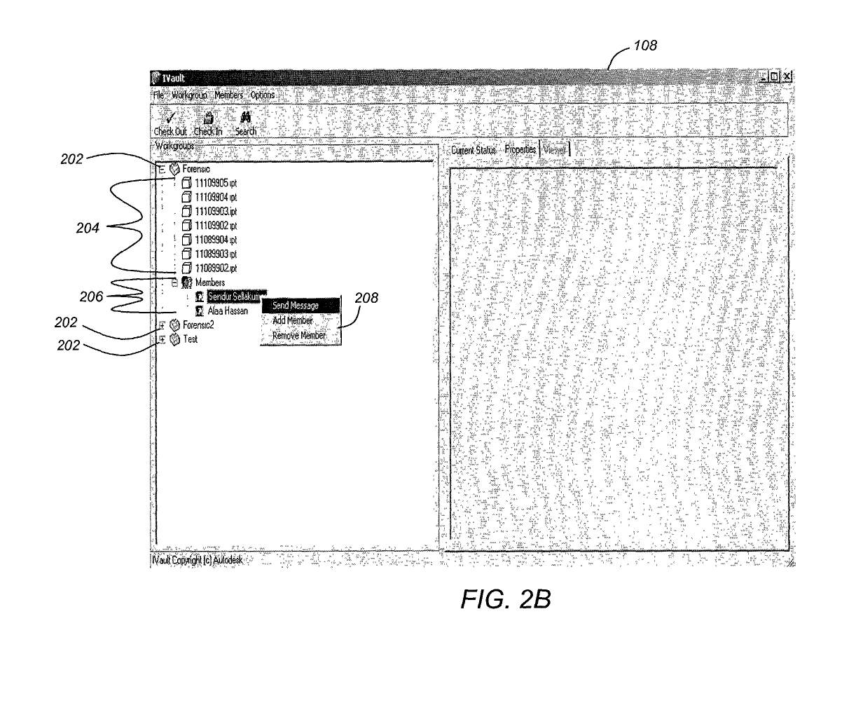

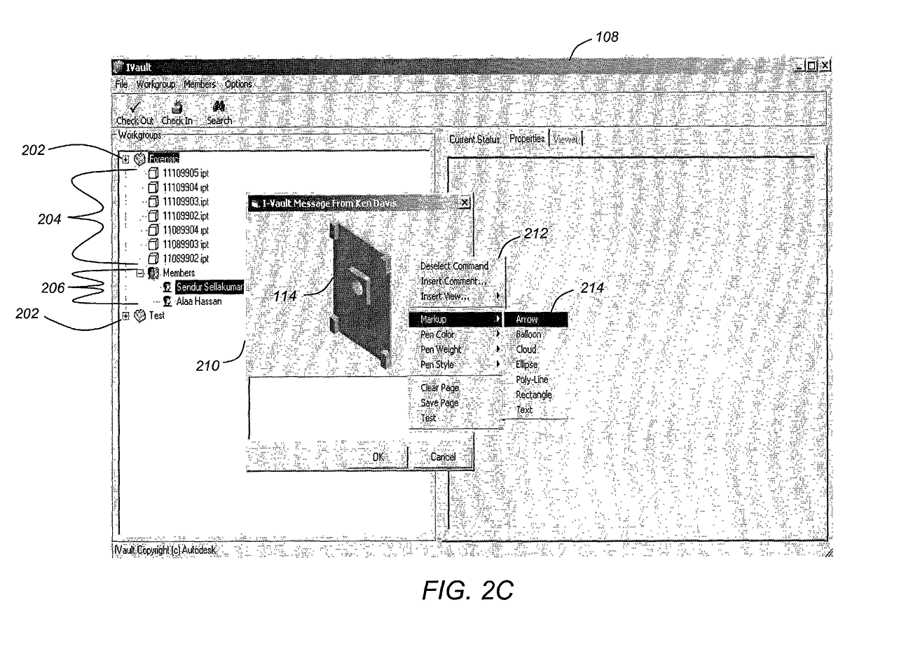

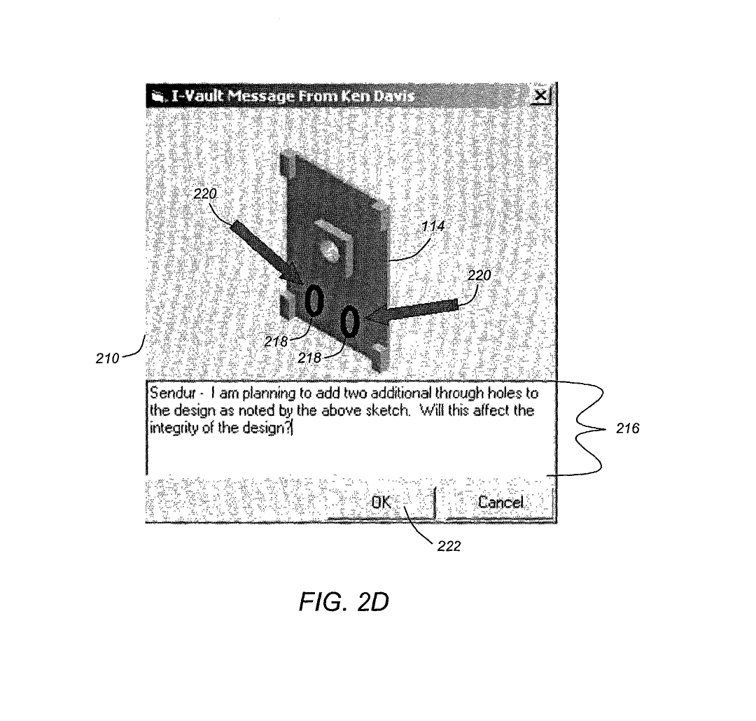

FIGS. 2A-2D are screen shots that illustrate the use of an instant messaging application 108 in accordance with one or more embodiments of the invention. In FIG. 2A, an instant messaging application 108 window is illustrated. In the particular instant messaging application 108 displayed, clients/users 104 may check in, check out, and conduct searches. Various folders, projects, or workgroups 202 are displayed in a window of instant messaging application 108. The individual files 204 and the members 206 of each workgroup 202 are also displayed.

In FIG. 2B, a user has selected a particular member 206 (e.g., by clicking the left button of a mouse/cursor control device, or selecting a particular sequence of keys). Once selected the user may elect to perform a particular action/command. For example, the user may activate a menu 208 by clicking a right button of a mouse/cursor control device, or entering a particular keyboard entry (or sequence of entries). Menu 208 provides the user with various options such as sending the selected member 206 a message, adding a member 206 to the workgroup 202, or removing the selected member 206 from the workgroup 202.

FIG. 2C illustrates the window of instant messaging application 108 upon a user selecting the command to send an instant message. Once the user selects the command to send an instant message a particular member 206 or group of members 206, a chat session is initialized with the selected member(s) 206. Further, a window 210 is used to reflect the instant messages transmitted between members 206. The window 210 is used to display a graphical image 114 that the user desires to markup. The selection of the particular graphical image 114 may be a default image set by the user. Alternatively, the user may elect to load a particular graphical image 114 using one or more additional commands.

The user may then elect/command (e.g., by clicking a cursor control device button over a desired location) to markup the graphical image 114. To markup the graphical image 114, a menu 212 may be displayed to the user. Such a menu may be a drop down menu from a file selection list or the menu 212 as displayed in FIG. 2C. Menu 212 allows a user to deselect a command, insert a comment, insert a view (e.g., a graphical image 114), clear a page, save a page, and test. Additionally, menu 212 provides submenus for markup entities, pen colors, pen weights, and pen styles.

The submenu for inserting a markup entity is window 214. Window 214 provides option for a user to insert an arrow markup entity, a balloon markup entity, a cloud markup entity, an ellipse markup entity, a poly-line markup entity, a rectangle markup entity, and a text markup entity. Once selected, the user may be provided with the option of selecting/identifying the location where the markup entity should be inserted. The user may also be provided with the option of modifying various settings for the markup entity using the other submenus of window 214 such as pen color, pen weight, and pen style. Additional formatting options may also be available to the user (e.g., size, orientation, font, etc.).

FIG. 2D illustrates window 210 after instant message text 216 has been entered and several markup entities 218-220 have been inserted and displayed on graphical image 114. The markup entities comprise two ellipses 218 and two arrows 220 pointing at the ellipses 218. A text markup could also have been entered that would be overlayed on top of graphical image 114. Additionally, window 210 illustrates the text 216 of an instant message that explains the markup entities 218-220 that have been entered. Once the appropriate text 216 and markups 218-220 have been entered, the user may elect to send the instant message to the selected member 206. To transmit the instant message and markups to the recipient member 206, a send button may be activated or the user may merely select the “OK” button 222. Alternatively, the markup entities 218-220 and text 216 may be transmitted in real time as the user types or inserts text 216 and markups 218-220.

Once the user has opted to transmit a markup (e.g., markups 218-220) and/or text (e.g., text 216) in the form of an instant message, instant messaging application 108 stores the markup information in a markup file 112. The markup information in markup file 112 comprises information sufficient to allow/instruct a receiving instant messaging application 108 how to display the markup entity. Accordingly, the markup information must contain sufficient information to identify the markup entity, the graphical image 114, and how the markup entity should be displayed on the graphical image 114. Such markup information may comprise a markup entity, a source reference that identifies the graphical image 114, and an orientation that indicates how the graphical image 114 should be displayed with regard to the markup entity.

As described in FIGS. 2A-2D, the instant messaging application 108 of the invention allows clients 104 to form workgroups and share design files. For example, a developer may display and transmit an instant message (e.g., to another developer) that indicates proposed design changes using an instant messaging application 108 that incorporates a view and markup tool. Thus, the user/client 104 originating the message creates the desired notes on a design and indicates that he would like to message the notes to a particular user or group of users in a workgroup. Each of the users receives the message and has opportunity to respond in the same manner.

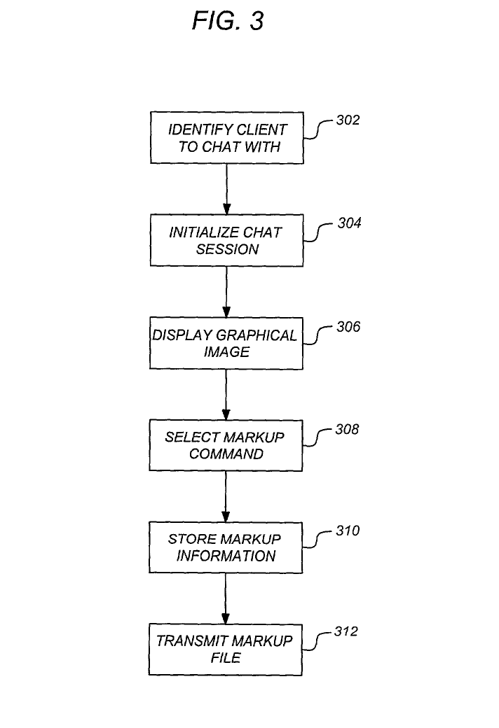

FIG. 3 is a flowchart illustrating the instant messaging process in accordance with one or more embodiments of the invention. At step 302, a second client 104 is identified at a first client 104 for participation in a chat/instant messaging session. The second client 104 may comprise an individual user/member a group of users/members. At step 304, a chat session is initialized between the first client 104 and second client 104. At step 306, a selected graphical image 114 is displayed on a display device 118 of the first client 104. At step 308, a command to markup the graphical image 114 is selected. The command may be selected from a menu 212-214 and may comprise a graphical image markup or text markup. Such a markup command may retrieve/obtain previously created markup information, or may create/generate new markup information for the graphical image 114.

At step 310, the markup information (including an identification of a markup entity, a source reference that identifies the graphical image, and an orientation that indicates how the graphical image 114 should be displayed with regard to the markup entity) is stored in a markup file 112. Such information may be stored in a document definition language such as XML. At step 312, the markup file 112 is transmitted to the second client 104. By using XML or another document definition language and by transmitting the markup file 112 through an instant messaging chat session, security measures utilized by a network 102 or server 106 are not violated. Thus, the markup file 112 is transmitted in a “firewall friendly” manner without breaching firewall security measures.

Once received by the second client 104, the second client 104 processes the markup information. Such processing may including determining the appropriate graphical image 114 (e.g., by examining the source reference) and loading the graphical image 114 from local storage. Thereafter, the markup entity is displayed by the second client 104 in the specified orientation on the graphical image 114.

Conclusion

This concludes the description of one or more embodiments of the invention. The following describes some alternative embodiments for accomplishing the present invention.

For example, any type of computer, such as a mainframe, minicomputer, work station or personal computer, could be used with the present invention. In addition, any program, function, or operating system that utilizes graphics applications, redline documents, or XML could potentially benefit from the present invention.

The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

TABLE 1
<Notebook>

<Markup>

<Objects>

<Arrow>

<Pen Weight=“3” Style-”0” Color=“16711680”/>
<Point2D x=“380.” Y=“7.”/>
<Point2D x=“401.” Y=“157.”/>
<Point2D x=“401.” Y=“157.”/>
<Point2D x=“395.” Y=“142.”/>
<Point2D x=“401.” Y=“141.”/>

</Arrow>
<Text textContent=“this tank is going to blow up”>

<Penweight=“3” Style=“0” Color=“255”/>
<Point2D x=“190.” Y=“371.”/>
<Point2D x=“502.” Y=“460.”/>

</Text>

<Objects>

</Markup>
<Comments/>
<Viewers>

<View type=“Hoops”>

<Ref location=“plant1/tank.hgs”/>
<Point2D x=“100.” Y=“40.” />
<Point2D x=“572.” Y=“321.”/>
<CameraPos x=“84.72137” y=“49.89976” z=“21.45923” />
<CameraTgt x=“28.09724” y=“1.866905” z=“10.37575” />
<CameraUVec x=“−0.1017718” y=“−0.1082126” z=“0.9889042” />
<Camera width=“30.0303” height=“30.0303” />
<CamerProjection value=“perspective” />
<Model />
<Image />

</View>

</Viewers>

</Notebook>

What is claimed is:

1. A computer-implemented method for displaying a markup of a graphical image comprising:
(a) receiving, in a first client, an identification of a second client to initiate a chat session with;
(b) initializing a chat session across a network between the first client and the second client;
(c) displaying a graphical image on the first client;
(d) selecting a command to markup the graphical image;
(e) in response to the command, storing markup information in a markup file separate from the graphical image, wherein the markup information comprises:
(i) a markup entity;
(ii) a source reference that identifies the graphical image; and
(iii) an orientation that indicates how the graphical image should be displayed with regard to the markup entity; and
(f) a transmitting the markup file across the network to the second client through the chat session, wherein in response to the transmission, the markup entity is caused to be displayed, in the orientation on the graphical image, on a display device of the second client.

2. The method of claim 1 wherein the graphical image is stored local to the second client.

3. The method of claim 1 wherein the command is selected from a menu.

4. The method of claim 1 wherein the markup entity comprises a second graphical image.

5. The method of claim 1 wherein the markup entity comprises text.

6. The method of claim 1 wherein the markup information comprises extensible markup language (XML).

7. The method of claim 1 wherein the second client comprises a particular user.

8. The method of claim 1 wherein the second client comprises a group of users.

9. The method of claim 1 wherein the chat session provides for the transmission of the markup file and text across the network without breaching firewall security measures.

10. The method of claim 1 wherein the method is implemented as part of an instant messaging application.

11. A computer-implemented system for displaying a markup of a graphical image, the system comprising:
(a) a first client computer;
(b) a display device connected to the first client computer;
(c) a graphical image stored on the first computer;
(d) an instant messaging application installed on the first client computer, wherein the instant messaging application is configured to:
(i) select a command to markup the graphical image;
(ii) in response to the command, store markup information in a markup file stored separately from the graphical image, wherein the markup information comprises:
(1) a markup entity;
(2) a source reference that identifies the graphical image; and
(3) an orientation that indicates how the graphical image should be displayed with regard to the markup entity;
(iii) receive an identification of a second client to receive the markup file;
(iv) initialize a chat session across a network with the second client;
(v) transmit the markup file across the network to the second client through the chat session; and
(vi) display the markup entity in the orientation on the graphical image on the display device.

12. The system of claim 11 wherein the instant messaging application is configured to display the markup file in the orientation on the graphical image on the display device in response to receiving the markup file during the chat session.

13. The system of claim 11 wherein the command is selected from a menu.

14. The system of claim 11 wherein the markup entity comprises a second graphical image.

15. The system of claim 11 wherein the markup entity comprises text.

16. The system of claim 11 wherein the markup information comprises extensible markup language (XML).

17. The system of claim 11 wherein the second client comprises a particular user.

18. The system of claim 11 wherein the second client comprises a group of users.

19. The system of claim 11 wherein the chat session provides for the transmission of the markup file and text across the network without breaching firewall security measures.

20. An article of manufacture embodying logic for displaying a markup of a graphical image, the logic comprising:
(a) receiving, in a first client, an identification of a second client to initiate a chat session with;
(b) initializing a chat session across a network between the first client and the second client;
(c) displaying a graphical image on the first client;
(d) selecting a command to markup the graphical image;
(e) in response to the command, storing markup information in a markup file separate from the graphical image, wherein the markup information comprises:
(i) a markup entity;
(ii) a source reference that identifies the graphical image; and
(iii) an orientation that indicates how the graphical image should be displayed with regard to the markup entity; and
(f) transmitting the markup file across the network to the second client through the chat session, wherein in response to the transmission, the markup entity is caused to be displayed, in the orientation on the graphical image, on a display device of the second client.

21. The article of manufacture of claim 20 wherein the graphical image is stored local to the second client.

22. The article of manufacture of claim 20 wherein the command is selected from a menu.

23. The article of manufacture of claim 20 wherein the markup entity comprises a second graphical image.

24. The article of manufacture of claim 20 wherein the markup entity comprises text.

25. The article of manufacture of claim 20 wherein the markup information comprises extensible markup language (XML).

26. The article of manufacture of claim 20 wherein the second client comprises a particular user.

27. The article of manufacture of claim 20 wherein the second client comprises a group of users.

28. The article of manufacture of claim 20 wherein the chat session provides for the transmission of the markup file and text across the network without breaching firewall security measures.

29. The article of manufacture of claim 20 wherein the method is implemented as part of an instant messaging application.
